(19) United States
(12) Patent Application Publication
(10) Pub. No.: US 2020/0412161 A1
(43) Pub. Date: Dec. 31, 2020

(54) SIDE MIRROR WIND TURBINE

(71) Applicant: K&N Engineering, Inc., Riverside, CA (US)

(72) Inventors: Jonathan Richard Fiello, Yucaipa, CA (US); Steve Williams, Cherry Valley, CA (US)

(73) Assignee: K&N Engineering, Inc., Riverside, CA (US)

(21) Appl. No.: 16/912,102

(22) Filed: Jun. 25, 2020

Related U.S. Application Data
(60) Provisional application No. 62/868,732, filed on Jun. 28, 2019.

(51) Int. Cl. H02J 7/34; F03D 9/25; F03D 13/20; H02J 7/00

(52) U.S. Cl. CPC H02J 7/34; F03D 9/25; H02J 7/0047; H02J 7/0045; F03D 13/20

(57) ABSTRACT

An apparatus and methods are provided for a wind turbine to be mounted on a vehicle for powering and charging portable electronic devices. The wind turbine comprises a nacelle configured to be mounted onto a side mirror of the vehicle. The nacelle includes an electric generator that rotates under the action of an inflowing airstream arising during forward movement of the vehicle. A charging station in electrical communication with the electric generator is configured to be located within an interior passenger cabin of the vehicle. The charging station encloses electric circuitry and one or more rechargeable batteries configured to convey electric power from the electric generator to the portable electronic devices. Multiple ports disposed in the charging station are configured to receive charger cables from the portable electronic devices. At least one power indicator is configured to indicate when electric power is being applied to the portable electronic devices.

### PRIORITY

This application claims the benefit of and priority to U.S. Provisional Application, entitled “Side Mirror Wind Turbine,” filed on Jun. 28, 2019 and having application Ser. No. 62/868,732, the entirety of said application being incorporated herein by reference.

### FIELD

Embodiments of the present disclosure generally relate to the field of providing energy to electronic devices. More specifically, embodiments of the disclosure relate to an apparatus and methods for a portable wind turbine for being mounted onto a vehicle side mirror and powering and charging portable electronic devices.

### BACKGROUND

A majority of today's electronic devices are specifically designed for portability and on-the-go use, including, for example, mobile phones or smart phones, portable music players, tablet computers, cameras, and the like. These devices typically require frequent recharging. Portable electronic devices generally include encased rechargeable batteries and are equipped with a remote charger, typically a transformer in conjunction with a rectifier capable of converting household AC (alternating current) into a suitable DC current. The remote charger usually may be coupled with the portable electronic device by way of a charger cable. Most modern electronic devices are compatible with the USB (Universal Serial Bus) specification for receiving power in the form of DC (direct current) electricity of approximately 5 volts.

A drawback to the remote chargers included with portable electronic devices is that they require a suitable power source, such as a wall outlet, a computer, or other similar power source. While away from such power sources, such as during long distance travel by car or truck, portable electronic devices are vulnerable to running out of battery power.

One option for powering portable electronic devices during traveling by car is to plug the charger cable into a car charger port. Car charger ports, however, often are configured to handle only a single cable at a time. Although adaptor devices are available for connecting multiple devices to a car charger port, such adapters tend to be bulky. Further, some car charger ports may continue powering portable electronic devices while the car's engine is turned off, potentially draining the car's battery.

Another option for powering portable electronic devices during traveling by car or truck is to capture the sun's solar energy by way of a photovoltaic cell or a series of such cells. Unfortunately, such solar cells generally require a relatively large area in order to capture enough solar energy to charge portable electronic devices. As such, solar cells tend to be cumbersome to set up in a car or truck. Further, solar cells typically become ineffective during cloudy conditions or at night.

Another option for powering portable electronic devices is to plug the charger cable into a portable battery pack. Although such portable battery packs work well, the portable battery pack must be eventually recharged, often times by way of a wall outlet. In absence of a suitable power source, therefore, portable battery packs are vulnerable to running out of battery power. Further, many portable battery packs are relatively fragile and thus are prone to potential damage due to impacts during storage or extreme temperatures while being left in a car or truck for long periods. Damage due to impacts and extreme temperatures generally reduce the performance of portable battery packs or may render them unusable.

There is a continuing interest, therefore, in developing convenient power sources capable of powering and charging portable electronic devices without relying on conventional power sources, such as car charger ports, solar cells, or portable battery packs.

### SUMMARY

An apparatus and methods are provided for a wind turbine to be mounted on a vehicle for powering and charging portable electronic devices. The wind turbine comprises a nacelle configured to be mounted onto a side mirror of the vehicle. The nacelle includes an electric generator that rotates under the action of an inflowing airstream arising during forward movement of the vehicle. A charging station in electrical communication with the electric generator is configured to be located within an interior passenger cabin of the vehicle. The charging station encloses electric circuitry and one or more rechargeable batteries configured to convey electric power from the electric generator to the portable electronic devices. Multiple ports disposed in the charging station are configured to receive charger cables from the portable electronic devices. At least one power indicator is configured to indicate when electric power is being applied to the portable electronic devices.

In an exemplary embodiment, a wind turbine to be mounted on a vehicle for powering and charging portable electronic devices comprises: a nacelle including an electric generator that rotates under the action of an inflowing airstream; a charging station in electrical communication with the electric generator; and one or more ports disposed in the charging station and configured to convey electric power to the portable electronic devices.

In another exemplary embodiment, the nacelle includes an air inlet that receives the airstream during forward movement of the vehicle. In another exemplary embodiment, a multiplicity of blades disposed within the nacelle are configured to rotate the electric generator under the action of the airstream. In another exemplary embodiment, the electric generator is configured to produce an electric current during rotation under the action of the airstream.

In another exemplary embodiment, the charging station is configured to be located within an interior passenger cabin of the vehicle. In another exemplary embodiment, the charging station is electrically coupled to the electric generator by way of a power cable configured to convey electric power from the electric generator to the charging station. In another exemplary embodiment, the charging station comprises a housing that encloses electric circuitry and one or more rechargeable batteries configured to convey electric power suitable for charging one or more portable electronic devices.

In another exemplary embodiment, the housing includes one or more ports configured to receive charger cables from the one or more portable electronic devices. In another exemplary embodiment, the charging station includes at least one power indicator configured to indicate when electric power is being applied to the one or more portable electronic devices. In another exemplary embodiment, a dedicated power indicator is associated with each of the one or more ports and configured to convey information about the status of a portable electronic device plugged into each of the one or more ports.

In another exemplary embodiment, the nacelle is configured to be fastened onto a side mirror of the vehicle by way of a mount attached to a clasp so as to orient the nacelle toward the front of the vehicle. In another exemplary embodiment, the clasp comprises a strip of rigid material that includes a curvature that substantially matches the curvature of an exterior surface of the side mirror. In another exemplary embodiment, the clasp includes curved portions at opposite ends configured to grip edges of the side mirror. In another exemplary embodiment, the clasp comprises metal or rigid plastic that is enclosed within a layer of pliable material, such as rubber or a similar material.

In another exemplary embodiment, a multiplicity of blades are coupled with a hub that is attached to a front of the generator and are generally concentric with an air inlet of the nacelle. In another exemplary embodiment, each of the multiplicity of blades includes a scooped cross-sectional shape that spirals around the center of the hub along the length of the blade. In another exemplary embodiment, the multiplicity of blades are configured to rotate the electric generator in response to the airstream entering through the air inlet, such that the electric generator produces an electric current to be conveyed to portable electric devices.

In an exemplary embodiment, a method for a wind turbine to be mounted on a vehicle for powering and charging portable electronic devices comprises: configuring a nacelle that includes an electric generator that rotates under the action of an airstream flowing through the nacelle; fabricating a clasp to support the nacelle on a side mirror of the vehicle; configuring a charging station to be located within an interior passenger cabin of the vehicle; placing the charging station in electrical communication with the electric generator by way of a power cable; fabricating one or more ports in the charging station whereby the portable electronic devices may be charged; and providing at least one power indicator to indicate when electric power is being applied to the portable electronic devices.

In another exemplary embodiment, configuring the nacelle includes coupling a multiplicity of blades with the electric generator such that the multiplicity of blades turn the electric generator under the action of the airstream. In another exemplary embodiment, configuring the charging station includes providing electric circuitry and one or more rechargeable batteries configured to convey electric power suitable for charging the portable electronic devices. In another exemplary embodiment, fabricating the clasp includes enclosing the clasp within a layer of pliable material suitable for containing the side mirror.

### BRIEF DESCRIPTION OF THE DRAWINGS

The drawings refer to embodiments of the present disclosure in which:

FIG. 1 illustrates a perspective view of an exemplary embodiment of a portable wind turbine installed onto a side mirror of a vehicle, in accordance with the present disclosure;

FIG. 2 illustrates a close-up perspective view of the portable wind turbine of FIG. 1 mounted onto the side mirror of the vehicle;

FIG. 3 illustrates an isometric view of an exemplary embodiment of a charging station comprising the portable wind turbine of FIG. 1;

FIG. 4 illustrates a front plan view of the portable wind turbine of FIG. 1 mounted onto the side mirror of the vehicle; and

FIG. 5 illustrates a cutaway view of the portable wind turbine of FIG. 1, according to the present disclosure.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first port,” may be made. However, the specific numeric reference should not be interpreted as a literal sequential order but rather interpreted that the “first port” is different than a “second port.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Modern electronic devices are designed for portability and on-the-go use, including, for example, mobile phones or smart phones, portable music players, tablet computers, cameras, and the like. These devices typically require frequent recharging. A drawback to remote chargers included with portable electronic devices is that they require a suitable power source, such as a wall outlet, a computer, or other similar power source. While away from such power sources, such as during long distance travel by car or truck, portable electronic devices are vulnerable to running out of battery power. As such, there is a continuing interest in developing convenient power sources capable of powering and charging portable electronic devices without relying on conventional power sources, such as car charger ports, solar cells, or portable battery packs. Embodiments disclosed herein relate to a portable wind turbine to be mounted onto a vehicle side mirror for powering and charging portable electronic devices.

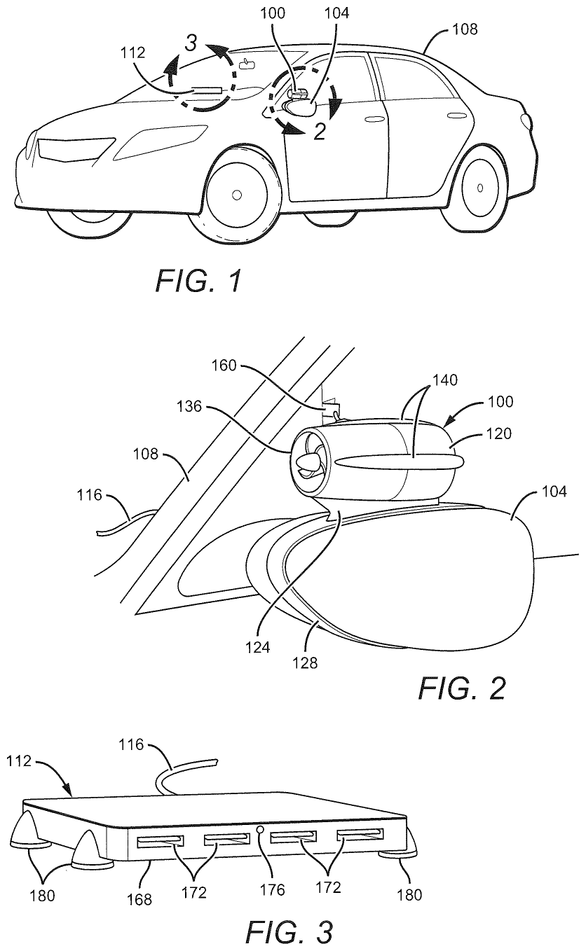

FIG. 1 illustrates a perspective view of an exemplary embodiment of a portable wind turbine 100 installed onto a side mirror 104 of a vehicle 108, in accordance with the present disclosure. A charging station 112 is disposed in a convenient, easy to reach location within an interior passenger cabin of the vehicle 108, such as on top of a dashboard of the vehicle 108 as shown in FIG. 1. The charging station 112 is electrically coupled to the wind turbine 100 by way of a power cable 116. As will be appreciated, the power cable 116 is configured to convey DC power from the wind turbine 100 to the charging station 112, as described herein.

In the embodiment of the wind turbine 100 shown in FIG. 1, the wind turbine 100 is mounted onto the side mirror 104 disposed on a driver side of the vehicle 108. It should be understood that driver side mounting of the wind turbine 100 is best suited for being operated by a driver of the vehicle 108. However, the wind turbine 100 is not to be limited to being mounted onto the driver side mirror 104 of the vehicle 108. As such, it is contemplated that the wind turbine 100 may be equivalently mounted onto a passenger side mirror (not shown), without limitation. For example, a passenger may assist the driver with remaining undistracted during operating the vehicle 108 by mounting the wind turbine 100 to the passenger side mirror and placing the charging station 112 on the dashboard of the vehicle.

FIG. 2 illustrates a close-up perspective view of the portable wind turbine 100 mounted onto the side mirror 104 of the vehicle 108. The wind turbine 100 generally comprises a nacelle 120 that is fastened to the side mirror 104 by way of a mount 124 attached to a clasp 128. The mount 124 may be attached to the clasp 128 by way of any of various suitable fasteners, adhesives, or other suitable devices. As best shown in FIG. 5, the clasp 128 generally comprises a strip of rigid material, such as metal or plastic, that includes a curvature that substantially matches the curvature of an exterior surface of the side mirror 104. The clasp 128 includes curved portions 132 at opposite ends that are configured to grip edges of the side mirror 104 so as to orient the nacelle 120 toward a front of the vehicle 108 as shown in FIG. 1. In some embodiments, the clasp 128 comprises metal or rigid plastic that is enclosed within a layer of pliable material, such as rubber or a similar material, so as to avoid scratching the painted exterior of the side mirror 104.

It should be understood that the clasp 128 need not be implemented as specifically shown in FIG. 5 and described hereinabove. For example, in some embodiments, the clasp 128 may comprise an elastic textile strip, and the curved portions 132 may comprise hooks, or other suitable devices, that are attached to opposite ends of the elastic textile strip. The mount 124 may be attached to the elastic strip by way of any of various suitable techniques. It is contemplated that, in such embodiments, the elastic textile strip may be stretched around the exterior of the side mirror 104 and the hooks engaged with the edges of the side mirror 104 such that the nacelle 120 is supported atop the side mirror 104 as shown in FIGS. 1-2.

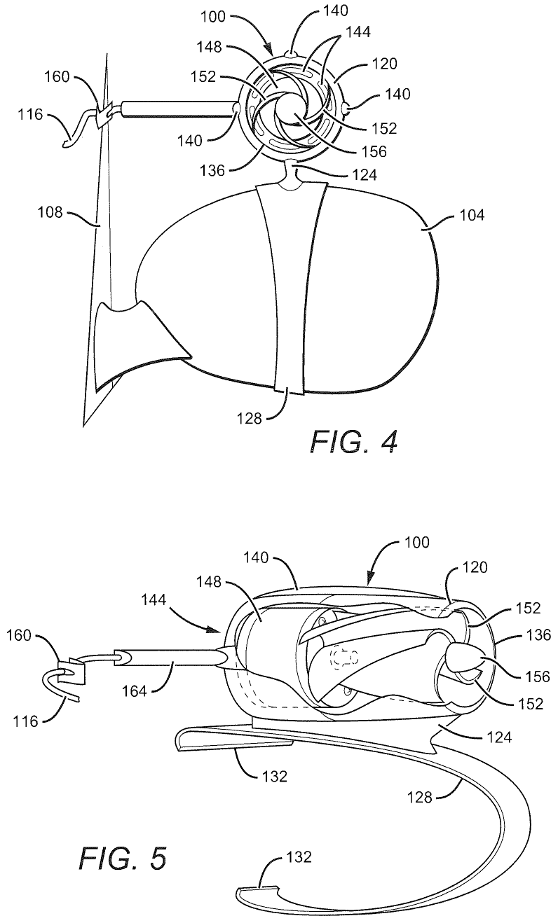

As best shown in FIGS. 1-2, the mount 124 and the clasp 128 are configured to orient the nacelle 120 such that an air inlet 136 of the nacelle 120 is oriented toward the front of the vehicle 108. It is contemplated that a forward-most position of the air inlet 136 will maximize an airstream entering the air inlet 136 while the vehicle 108 is moving. The nacelle 120 may include multiple strakes 140 disposed longitudinally along the nacelle 120 and configured to reduce turbulence of the airstream entering the air inlet 136. In the illustrated embodiment of FIG. 4, for example, three strakes 140 are disposed on the nacelle 120 at 90-degree intervals around the circumference of the nacelle 120 and are configured to operate in combination with the mount 124 to reduce air turbulence. It is contemplated that, in some embodiments, any of various aerodynamic shapes or features may be incorporated into the nacelle 120 so as to improve entry of the airstream into the air inlet 136, without limitation.

With continuing reference to FIG. 4, one or more air outlet ports 144 may be disposed at a rear-most portion of the nacelle 120 and configured to allow the airstream entering the air inlet 136 to exit through the rear of the nacelle 120. In the illustrated embodiment, the air outlet ports 144 are circumferentially arranged at the rear of the nacelle 120. Each of the air outlet ports 144 is generally elongate and curved so as to allow the airstream to pass around the exterior of an electric generator 148 rotatably mounted inside the nacelle 120. It is contemplated that any number of air outlet ports 144 may be implemented with any of various shapes, sizes, and arrangements on the nacelle 120 without limitation, and without deviating beyond the scope of the present disclosure.

As best shown in FIG. 4, multiple blades 152 are coupled with a hub 156 that is generally concentric with the air inlet 136 and the electric generator 148. In the illustrated embodiment, four blades 152 are coupled with the hub 156, however any number of blades 152 may be incorporated into the wind turbine 100, without limitation. As best shown in FIG. 5, the blades 152 and the huh 156 are attached to a front of the electric generator 148. Each of the blades 152 includes a scooped cross-sectional shape that spirals around the center of the hub 156 along the length of the blades 152. As such, the blades 152 are configured to turn the electric generator 148 in response to the airstream entering through the air inlet 136 and exiting through the air outlet ports 144. Further, the blades 152 are configured to rotate the electric generator 148 in a clockwise direction, as shown in FIG. 4, for the purpose of producing electricity. It should be recognized, however, that the blades 152 may be configured, in some embodiments, to rotate the electric generator 148 in a counterclockwise direction, as may be desired, and without limitation. As such, the specific cross-sectional shape and direction of the spiral of the blades 152 shown in FIGS. 4-5 are not to be construed as limiting in nature, and thus the blades 152 may be altered to accommodate a wide variety of makes and models of the electric generator 148, without limitation.

In general, during forward motion of the vehicle 108 the airstream passes into the air inlet 136 and through the nacelle 120, wherein the airstream advantageously causes the blades 152 and the electric generator 148 to rotate. As will be appreciated, the electric generator 148 is configured to produce an electric current during rotating. The power cable 116 is configured to convey the electric current from the electric generator 148 to the charging station 112. As shown in FIGS. 4-5, the power cable 116 includes a window anchor 160 configured to attach the power cable 116 to a window channel of the vehicle 108. It is contemplated that once the window anchor 160 is inserted into the window channel, the driver side window may be lowered and raised without interfering with the placement of the power cable 116.

With continuing reference to FIGS. 4-5, the power cable 116 is sheathed within a wind bridge 164 that extends from the rear of the nacelle 120 to the portion of the power cable 116 that is anchored in the window channel. The wind bridge 164 comprises a relatively rigid sheath that is configured to support the portion of the power cable 116 between the nacelle 120 and the vehicle 108 that is subjected to wind during forward motion of the vehicle 108. The wind bridge 164 generally is fastened to the rear of the nacelle 120 so as to prevent the power cable 116 from flapping in the wind while the vehicle 108 is moving. In some embodiments, the wind bridge 164 comprises a sheath that is molded onto the portion of the power cable 116 near the nacelle 120. In some embodiments, the wind bridge 164 is a separate component that includes a longitudinal channel configured to fixedly receive a length of the power cable 116 near the nacelle 120. In such embodiments, the power cable 116 may be pressed into the longitudinal channel of the wind bridge 164 and then wind bridge 164 may be fixated to the nacelle 120.

Turning, now, to FIG. 3, an exemplary embodiment of a charging station 112 is shown that may be coupled with the wind turbine 100 by way of the power cable 116. In general, the charging station 112 comprises a housing 168 that encloses electric circuitry and one or more rechargeable batteries configured to convey DC electric power suitable for charging portable electronic devices. It is contemplated that such portable electronic devices may include, but are not limited to, mobile phones or smart phones, portable music players, tablet computers, cameras, and the like. As such, the housing 168 includes one or more ports 172 configured to receive charger cables from the portable electronic devices. In an embodiment, the ports 172 comprise four USB ports, but other port configurations and numbers of the ports 172 may be implemented, without limitation.

As shown in FIG. 3, a power indicator 176 may be incorporated into the charging station 112 and configured to indicate when electric power is being applied to a portable electronic device that is plugged into any one of the ports 172. For example, in some embodiments, when a portable electronic device is plugged into one of the ports 172, the power indicator 176 may illuminate to indicate that the portable electronic device is successfully being charged. The power indicator 176 may turn off once the portable electronic device is fully charged. In some embodiments, the power indicator 176 may illuminate with a first color whenever electric power is available for charging portable electronic devices and illuminate with a second color during charging one or more portable electronic devices. For example, in some embodiments, the power indicator 176 may illuminate a green color when electric power is available and then illuminate a red color when a portable electronic device is plugged into one of the ports 172. In such embodiments, the power indicator 176 may return to the first, green color once the portable electronic device is fully charged.

Although a single power indicator 176 is disposed in the charging station 112 illustrated in FIG. 3, it is contemplated that, in some embodiments, a dedicated power indicator 176 may be advantageously associated with each of the ports 172, without limitation. As such, each dedicated power indicator 176 may be configured to convey information about the status of the device plugged into each of the ports 172. In one embodiment, for example, a first power indicator 176 may be illuminated red to indicate that a first device plugged into a first port 172 is being charged while a second power indicator 176 may be illuminated green to indicate that a second device plugged into a second port 172 is fully charged. It should be understood, therefore, that the power indicators 176 may be implemented in a wide variety of different configurations and with various functionalities, without limitation, and without straying beyond the scope of the present invention.

In the illustrated embodiment of FIG. 3, the charging station 112 includes one or more feet 180 configured to support the charging station 112 on a relatively flat surface, such as a dashboard or an inside of a windshield of the vehicle 108. It is contemplated that the feet 180 may be configured to affix the charging station 112 to the surface so as to prevent movement of the charging station 112 while the vehicle 108 is in operation. In some embodiments, each of the feet 180 includes a suction cup configured to affix the charging station 112 to the surface. In practice, the suction cups may be wetted and then pressed onto the surface to attach the charging station 112 to the surface. In some embodiments, the feet 180 may each include an adhesive pad suitable for mounting the charging station 112 to the surface. The adhesive pads may comprise portions of double-sided sticky foam tape that may be pressed between the feet 180 and the surface so as to affix the charging station 112 to the surface.

Moreover, in some embodiments, magnets may be incorporated into the feet 180 and configured to attach the charging station 112 to any of various magnetic surfaces. In some embodiments, however, metal sheet portions may be affixed to a nonmagnetic surface, such as a padded dashboard, by way of adhesive pads and then the magnetic feet 180 may be attached to the metal sheet portions to mount the charging station 112 to the nonmagnetic surface. It is contemplated that magnetic feet 180 advantageously enable the charging station 112 to be moved, as desired, such as during cleaning of the dashboard of the vehicle 108. It should be understood that the feet 180 may be implemented in a wide variety of configurations other than those specifically shown and described herein, without limitation, and without deviating beyond the spirit and scope of the present disclosure.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. A wind turbine to be mounted on a vehicle for powering and charging portable electronic devices, the wind turbine comprising:
a nacelle including an electric generator that rotates under the action of an inflowing airstream;
a charging station in electrical communication with the electric generator; and
one or more ports disposed in the charging station and configured to convey electric power to the portable electronic devices.

2. The wind turbine of claim 1, wherein the nacelle includes an air inlet that receives the airstream during forward movement of the vehicle.

3. The wind turbine of claim 2, wherein a multiplicity of blades disposed within the nacelle are configured to rotate the electric generator under the action of the airstream.

4. The wind turbine of claim 3, wherein the electric generator is configured to produce an electric current during rotation under the action of the airstream.

5. The wind turbine of claim 1, wherein the charging station is configured to be located within an interior passenger cabin of the vehicle.

6. The wind turbine of claim 1, wherein the charging station is electrically coupled to the electric generator by way of a power cable configured to convey electric power from the electric generator to the charging station.

7. The wind turbine of claim 1, wherein the charging station comprises a housing that encloses electric circuitry and one or more rechargeable batteries configured to convey electric power suitable for charging one or more portable electronic devices.

8. The wind turbine of claim 7, wherein the housing includes one or more ports configured to receive charger cables from the one or more portable electronic devices.

9. The wind turbine of claim 8, wherein the charging station includes at least one power indicator configured to indicate when electric power is being applied to the one or more portable electronic devices.

10. The wind turbine of claim 9, wherein a dedicated power indicator is associated with each of the one or more ports and configured to convey information about the status of a portable electronic device plugged into each of the one or more ports.

11. The wind turbine of claim 1, wherein the nacelle is configured to be fastened onto a side mirror of the vehicle by way of a mount attached to a clasp so as to orient the nacelle toward the front of the vehicle.

12. The wind turbine of claim 11, wherein the clasp comprises a strip of rigid material that includes a curvature that substantially matches the curvature of an exterior surface of the side mirror.

13. The wind turbine of claim 12, wherein the clasp includes curved portions at opposite ends configured to grip edges of the side mirror.

14. The wind turbine of claim 13, wherein the clasp comprises metal or rigid plastic that is enclosed within a layer of pliable material, such as rubber or a similar material.

15. The wind turbine of claim 1, wherein a multiplicity of blades are coupled with a hub that is attached to a front of the generator and are generally concentric with an air inlet of the nacelle.

16. The wind turbine of claim 15, wherein each of the multiplicity of blades includes a scooped cross-sectional shape that spirals around the center of the hub along the length of the blade.

17. The wind turbine of claim 16, wherein the multiplicity of blades are configured to rotate the electric generator in response to the airstream entering through the air inlet, such that the electric generator produces an electric current to be conveyed to portable electric devices.

18. A method for a wind turbine to be mounted on a vehicle for powering and charging portable electronic devices, the method comprising:
configuring a nacelle that includes an electric generator that rotates under the action of an airstream flowing through the nacelle;
fabricating a clasp to support the nacelle on a side mirror of the vehicle;
configuring a charging station to be located within an interior passenger cabin of the vehicle;
placing the charging station in electrical communication with the electric generator by way of a power cable;
fabricating one or more ports in the charging station whereby the portable electronic devices may be charged; and
providing at least one power indicator to indicate when electric power is being applied to the portable electronic devices.

19. The method of claim 18, wherein configuring the nacelle includes coupling a multiplicity of blades with the electric generator such that the multiplicity of blades turn the electric generator under the action of the airstream.

20. The method of claim 18, wherein configuring the charging station includes providing electric circuitry and one or more rechargeable batteries configured to convey electric power suitable for charging the portable electronic devices.

21. The method of claim 18, wherein fabricating the clasp includes enclosing the clasp within a layer of pliable material suitable for containing the side mirror.
